(19) United States
(12) Patent Application Publication
(10) Pub. No.: US 2025/0294619 A1
(43) Pub. Date: Sep. 18, 2025

(54) TRIGGERED RANDOM ACCESS FOR DEVICE IDENTIFICATION

(71) Applicant: Samsung Electronics Co., Ltd., Suwon-si (KR)

(72) Inventors: Jeongho Jeon, San Jose, CA (US); Ebrahim MolavianJazi, San Jose, CA (US); Aristides Papasakellariou, Houston, TX (US)

(21) Appl. No.: 19/075,608

(22) Filed: Mar. 10, 2025

Related U.S. Application Data
(60) Provisional application No. 63/566,763, filed on Mar. 18, 2024.

(51) Int. Cl. H04W 74/0833; H04W 4/70

(52) U.S. Cl. CPC H04W 74/0833; H04W 4/70

(57) ABSTRACT

Apparatuses and methods for triggered random access for device identification. A method for an Internet of Things (IoT) device to communicate with a reader for device identification includes receiving a first physical reader-to-device channel (PRDCH), transmitting a first physical device-to-reader channel (PDRCH), and receiving a second PRDCH. The first PRDCH triggers a device identification procedure. The first PRDCH provides information related to a target device. The first PRDCH provides parameters related to random access resources. The first PDRCH is transmitted on a randomly selected resource based on the parameters. The first PDRCH includes a random number. The second PRDCH includes the random number provided in the first PDRCH. The second PRDCH provides information related to transmission of a second PDRCH. The method further includes determining, based on reception of the second PRDCH, successful transmission of the first PDRCH and transmission of the second PDRCH and transmitting the second PDRCH.

### CROSS-REFERENCE TO RELATED AND CLAIM OF PRIORITY

The present application claims priority under 35 U.S.C. § 119(e) to U.S. Provisional Patent Application No. 63/566,763 filed on Mar. 18, 2024, which is hereby incorporated by reference in its entirety.

### TECHNICAL FIELD

The present disclosure relates generally to wireless communication systems and, more specifically, the present disclosure is related to apparatuses and methods for triggered random access for device identification.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to triggered random access for device identification.

In one embodiment, a method for an Internet of Things (IoT) device to communicate with a reader for device identification is provided. The method includes receiving a first physical reader-to-device channel (PRDCH), transmitting a first physical device-to-reader channel (PDRCH), and receiving a second PRDCH. The first PRDCH triggers a device identification procedure. The first PRDCH provides information related to a target device indicating one or more device identifiers corresponding to one or more devices, respectively, a device-group identifier corresponding to one or more devices, or no identifier corresponding to all devices receiving the first PRDCH. The first PRDCH provides parameters related to random access resources including at least one of one or more time slots for time-division multiple access (TDMA), and one or more frequency shifts for frequency-division multiple access (FDMA). The first PDRCH is transmitted on a randomly selected resource based on the parameters related to the random access resources indicated in the first PRDCH. The first PDRCH includes a random number. The second PRDCH includes the random number provided in the first PDRCH. The second PRDCH provides information related to transmission of a second PDRCH. The method further includes determining, based on reception of the second PRDCH, successful transmission of the first PDRCH and transmission of the second PDRCH and transmitting, based on the determination of the transmission of the second PDRCH and the information related to the transmission of the second PDRCH provided in the second PRDCH, the second PDRCH.

In another embodiment, an IoT device to communicate with a reader for device identification is provided. The IoT device includes a transceiver configured to receive a first PRDCH, transmit a first PDRCH, and receive a second PRDCH. The first PRDCH triggers a device identification procedure. The first PRDCH provides information related to a target device indicating one or more device identifiers corresponding to one or more devices, respectively, a device-group identifier corresponding to one or more devices, or no identifier corresponding to all devices receiving the first PRDCH. The first PRDCH provides parameters related to random access resources including at least one of one or more time slots for TDMA, and one or more frequency shifts for FDMA. The first PDRCH is transmitted on a randomly selected resource based on the parameters related to the random access resources indicated in the first PRDCH. The first PDRCH includes a random number. The second PRDCH includes the random number provided in the first PDRCH. The second PRDCH provides information related to transmission of a second PDRCH. The IoT device further includes processing circuitry configured to determine, based on reception of the second PRDCH, successful transmission of the first PDRCH and transmission of the second PDRCH. The transceiver is further configured to transmit, based on the determination of the transmission of the second PDRCH and the information related to the transmission of the second PDRCH provided in the second PRDCH, the second PDRCH.

In yet another embodiment, a reader is provided. The reader includes a transceiver configured to transmit a first PRDCH, receive, from an IoT device a first PDRCH, and transmit a second PRDCH. The first PRDCH triggers a device identification procedure. The first PRDCH provides information related to a target device indicating one or more device identifiers corresponding to one or more devices, respectively, a device-group identifier corresponding to one or more devices, or no identifier corresponding to all devices receiving the first PRDCH. The first PRDCH provides parameters related to random access resources including at least one of one or more time slots for TDMA and one or more frequency shifts for FDMA. The first PDRCH is received on a randomly selected resource based on the parameters related to the random access resources indicated in the first PRDCH. The first PDRCH includes a random number. The second PRDCH includes the random number provided in the first PDRCH. The second PRDCH provides information related to a second PDRCH. The reader further includes a processor operably coupled to the transceiver. The processor is configured to determine, based on reception of the first PDRCH, successful transmission of the first PRDCH. The transceiver is further configured to receive the second PDRCH based on the information related to the second PDRCH provided in the second PRDCH.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency-division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure;

FIG. 9 illustrates a diagram of an example type-1 backscatter structure for internet of thing(s) (IoT) devices according to embodiments of the present disclosure;

FIG. 10 illustrates a diagram of an example impedance matching circuit according to embodiments of the present disclosure;

FIG. 11 illustrates a diagram of an example type-2a backscatter structure for IoT devices according to embodiments of the present disclosure;

FIG. 12 illustrates a diagram of an example type-2b backscatter structure for IoT devices according to embodiments of the present disclosure;

FIG. 13 illustrates a diagram of an example type-2b backscatter structure for IoT devices according to embodiments of the present disclosure;

FIG. 14 illustrates a diagram of an example type-2b backscatter structure for IoT devices according to embodiments of the present disclosure;

FIG. 15 illustrates a flowchart of an example procedure for triggered random access for device identification according to embodiments of the present disclosure;

FIG. 16 illustrates a signal flow of an example procedure for triggered random access for device identification according to embodiments of the present disclosure;

FIG. 17 illustrates a diagram of an example physical reader to device channel (PRDCH) frame structure according to embodiments of the present disclosure;

FIG. 18 illustrates a timeline of an example sequential device identification process according to embodiments of the present disclosure;

FIG. 19 illustrates a timeline of an example multiplexed identification process according to embodiments of the present disclosure; and

FIG. 20 illustrates a diagram of an example PRDCH transmission architecture according to embodiments of the present disclosure.

### DETAILED DESCRIPTION

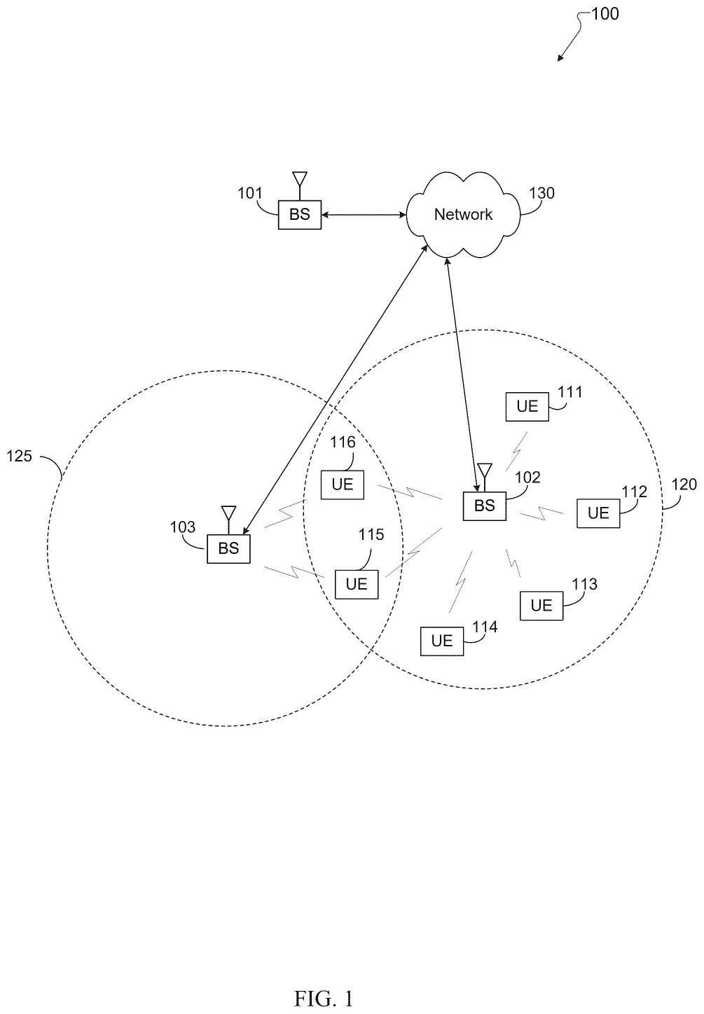

FIGS. 1-20, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF1] 3GPP TS 38.211 v18.1.0, “NR; Physical channels and modulation;” [REF2] 3GPP TS 38.212 v18.1.0, “NR; Multiplexing and channel coding;” [REF3] 3GPP TS 38.213 v18.1.0, “NR; Physical layer procedures for control;” [REF4] 3GPP TS 38.214 v18.1.0, “NR; Physical layer procedures for data;” [REF5] 3GPP TS 38.331 v18.0.0, “NR; Radio Resource Control (RRC) protocol specification;” and [REF6] 3GPP TS 38.321 v18.0.0, “NR; Medium Access Control (MAC) protocol specification.”

FIGS. 1-3 below describe various embodiments implemented in wireless communications systems and with the use of orthogonal frequency-division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting triggered random access for device identification. In certain embodiments, one or more of the gNBs 101-103 include circuitry, programing, or a combination thereof to provide for triggered random access for device identification.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

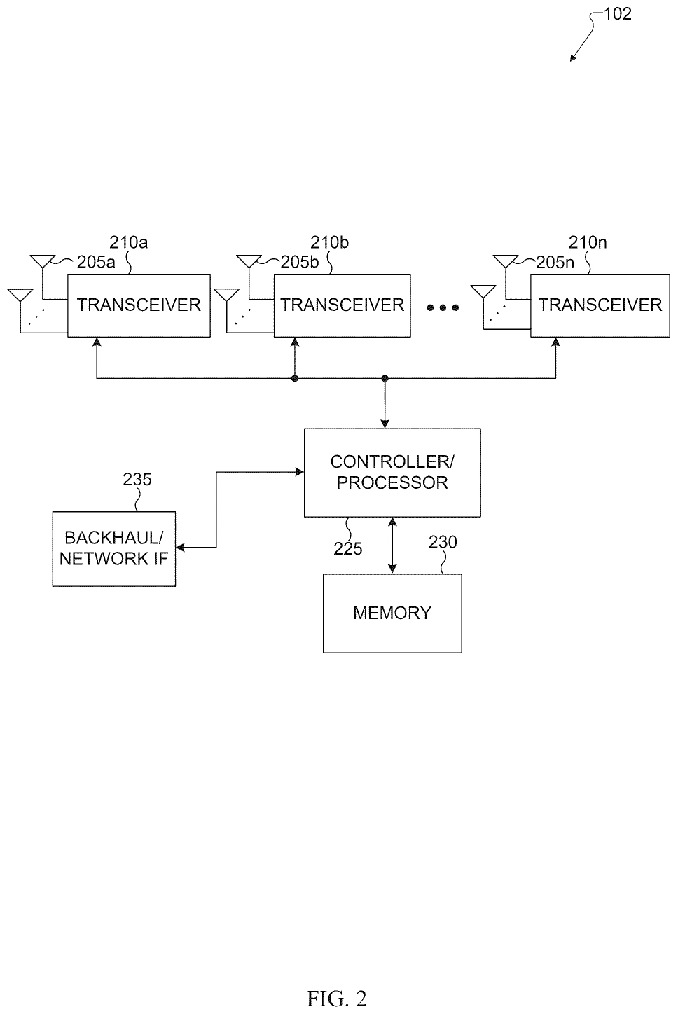

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for triggered random access for device identification. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

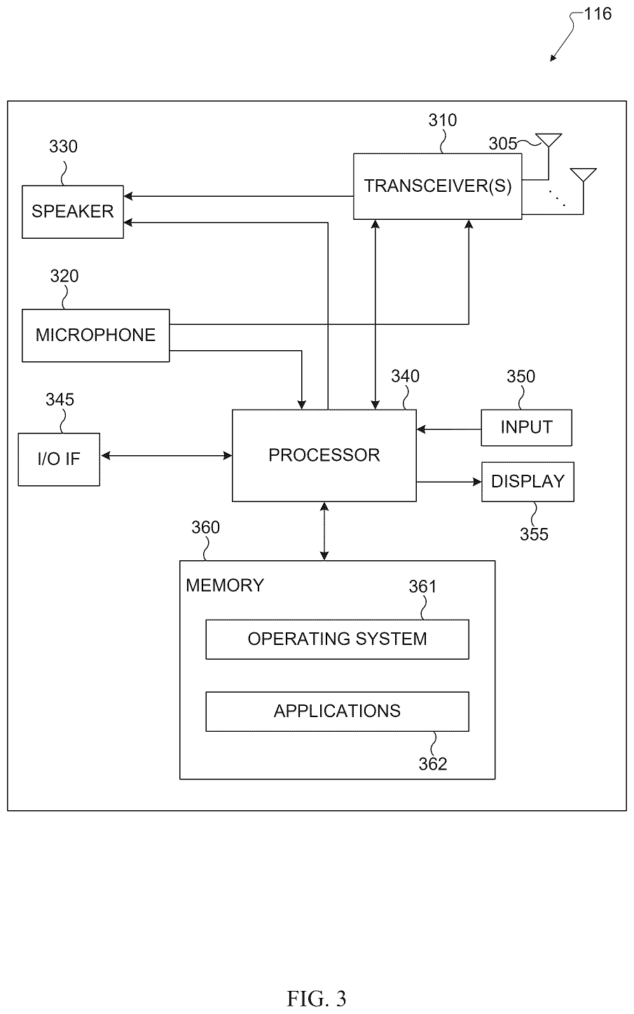

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support triggered random access for device identification as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

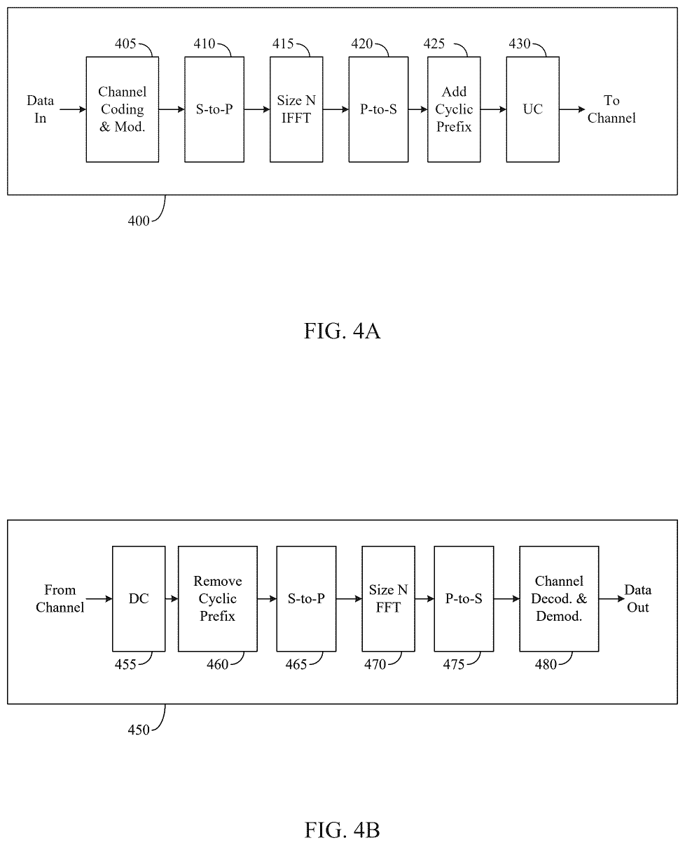

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 perform or utilize triggered random access for device identification as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Internet of things (IoT) devices include ambient-power-enabled IoT (A-IoT) devices, which are ultra-low-complexity devices with very small form factor and low-cost design that operate without a common battery that can be manually replaced or recharged. Instead, A-IT devices can be battery-less or with a small battery (such as a small capacitor) that operate based on energy harvesting from RF waveforms or other ambient energy sources. Regarding the limited size and complexity required by practical applications for battery-less devices with no energy storage capability or devices with limited energy storage that do not need to be replaced or recharged manually, the output power of energy harvester is typically from 1 μW to a few hundreds of μW.

In various embodiments throughout the disclosure, a UE (e.g., the UE 116) or a device may be referred to as an A-IoT device or an A-IoT UE based on energy harvesting with ultra-low complexity and power consumption and for low-end IoT applications. For example, the UE may have limited (or no) energy storage or battery capability (e.g., a capacitor), such as an energy storage unit for amplification of receptions at the UE or transmission by the UE, or for other UE operations, such as power-on, warm-up, memory, internal processing, and so on, or operating with backscattering communication.

An A-IoT device can be an IoT device that satisfies one or more of the following (or variations thereof):
powered by energy harvesting, being either battery-less or with limited energy storage capability (e.g., using a capacitor) and the energy is provided through the harvesting of radio waves (including RF waveforms), light (including solar light or indoor light), motion, pressure, heat, or any other power source that could be seen suitable;
with low complexity, small size and lower capabilities and lower power consumption than previously defined 3GPP IoT devices (e.g., NB-IoT/enhanced machine type communication (eMTC) devices);
maintenance free and can have long life span (e.g., more than 10 years).

An A-IoT may directly communicate with a base station/gNB (e.g., the BS 102) (e.g., operating as a reader), or may indirectly communicate with a reader through an intermediate/assisting node, such as a handheld device/UE (for example, a “reader” UE that scans the A-IoT devices), a relay, integrated access and backhaul (IAB) node, a repeater for example a network-controlled repeater (NCR), and so on. The communication can be mono-static wherein the transmitter node to the A-IoT UE is same as the receiving node from the A-IoT UE, or can be bi-static (or multi-static) wherein the transmitter nodes to the A-IoT UE can be different from the receiving nodes from the A-IoT UE.

In various embodiments, the A-IoT device operates with energy storage and power management capability. These devices are characterized by ultra-low power consumption, and they employ energy harvesting mechanisms such as solar, RF energy and kinetic energy and thus don't require battery replacement or swapping frequently. In various embodiments, an A-IoT device operates with energy harvesting (EH) or with limited (or no) energy storage/battery capability (such as a capacitor), such as an energy storage unit for amplification of receptions at the UE or transmission by the UE, or for other UE operations, such as power-on, warm-up, memory, internal processing, and so on, or operating with backscattering communication.

In various embodiments, the A-IoT device operates with RF envelope detection for receiving amplitude shift keying (ASK), e.g., OOK, modulated signal. RF envelope detection is a key function that enables the Ambient IoT devices to filter and analyze RF signals. This technique is applied in the reception of modulated RF signals with a view of acquiring information from the signals and hence enable communication between devices with efficiency and with minimum power consumption. RF envelope detection is one of the most important techniques that are used in many of the low power consumption wireless communication protocols that are employed in Ambient IoT systems.

In various embodiments, the A-IoT device may operate with impedance matching. Impedance matching may be utilized in passive Ambient IoT devices backscattering externally provisioned carrier wave (CW) signal.

The disclosure relates to defining functionalities and procedures for A-IoT devices to perform triggered random access for device identification. DL and UL are also referred to as reader-to-device (R2D) and device-to-reader (D2R), respectively, and vice versa.

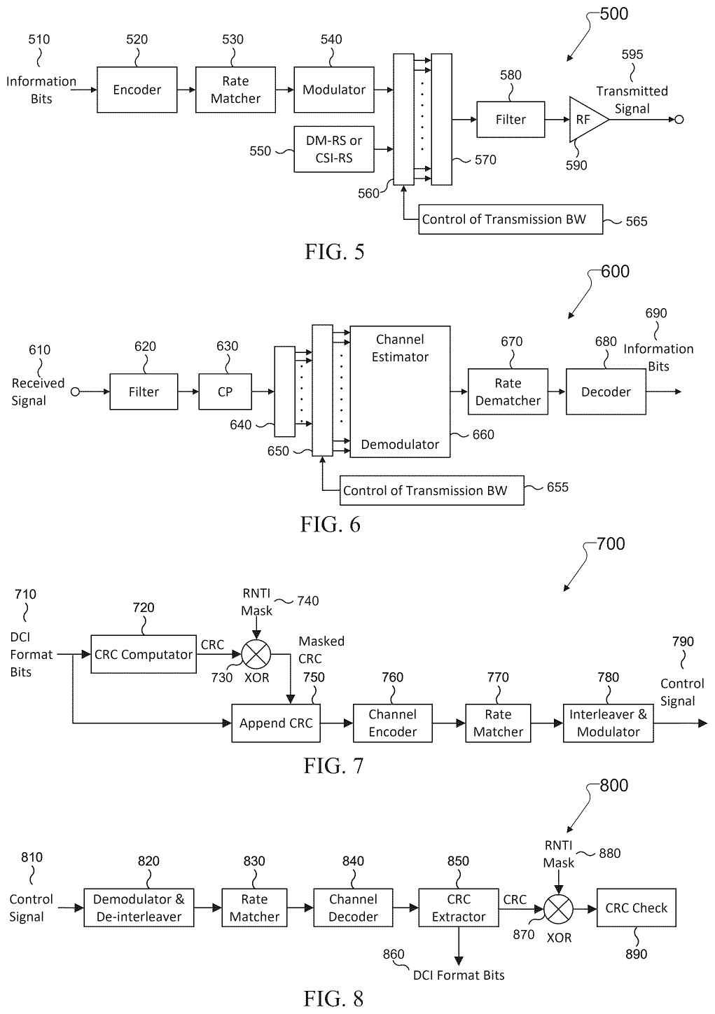

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR(0,0)=0, XOR(0,1)=1, XOR(1,0)=1, XOR(1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

It is envisaged that the number of connected devices will reach ˜500 billion by 2030, which is about ˜59 times larger than the expected world population (˜8.5 billion) by that time. Mobile devices will take various form-factors, such as augmented reality (AR) glasses, virtual reality (VR) headsets, hologram devices, while a large portion of the devices will be Internet-of-Things (IoT) devices for improving productivity efficiency and increasing comforts of life. As the number of IoT devices grows exponentially, those IoT devices will become dominant in the next generation wireless communication systems such as fifth generation (5G) advanced, sixth generation (6G) systems, and so on.

With the explosive number of IoT devices, it may be challenging to power the IoT devices by battery that needs to be replaced or recharged manually, which leads to high maintenance cost. The automation and digitalization of various industries demand new IoT technologies of supporting batteryless devices with no energy storage capability or devices with energy storage that does not need to be replaced or recharged manually. Such types of devices are collectively termed as ambient IoT (A-IoT) in this disclosure, which is powered by various renewable energy sources such as radio waves, light, motion, or heat, etc. Use cases of A-IoT devices include asset inventory/tracking and remote environmental monitoring. The following list provides example use cases of A-IoT devices:
Indoor inventory
   Automated warehousing
   Medical instruments inventory management and positioning
   Non-Public Network for logistics
   Automobile manufacturing
   Airport terminal/shipping port
   Smart laundry
   Automated supply chain distribution
   Fresh food supply chain
   End-to-end logistics
   Flower auction
   Electronic shelf label
Indoor sensor
   Smart homes
   Base station machine room environmental supervision
   Smart laundry
   Smart agriculture
   Smart pig farm
   Cow stable
Indoor positioning
   Finding Remote Lost Item
   Location service
   Ranging in a home
   Personal belongings finding
   Positioning in shopping centre
   Museum Guide
Indoor command
   Online modification of medical instruments status
   Device activation and deactivation
   Elderly Health Care
   Device Permanent Deactivation
   Electronic shelf label
Outdoor inventory
   Medical instruments inventory management and positioning
   Non-public network for logistics
   Airport terminal/shipping port
   Automated supply chain distribution
Outdoor sensor
   Smart grids
   Forest Fire Monitoring
   Dairy farming
   Smart manhole cover safety monitoring
   Smart bridge health monitoring
Outdoor positioning
   Finding remote lost item
   Location service
   Personal belongings finding
Outdoor command
   Online modification of medical instruments status
   Device activation and deactivation
   Elderly Health Care
   Controller in smart agriculture

Taking into account the limited size and low complexity required by practical applications of A-IoT devices, the output power of energy harvesting from ambient power sources is typically from 1 μW to a few hundreds of μW, which is orders of magnitude lower than normal user equipment (UE) having peak power consumption higher than 10 mW. This requires a new wireless access technology for A-IoT devices, which cannot be fulfilled by existing cellular systems including low-power IoT technologies such as NB-IoT and eMTC.

In the following, an italicized name for a parameter implies that the parameter is provided by higher layers.

DL (e.g., PRDCH) transmissions or UL (e.g., PDRCH) transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments provide a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in v17.6.0 of REF1 and v17.6.0 of REF3.

DCI can serve several purposes. A DCI format includes a number of fields, or information elements (IEs), and is typically used for scheduling a PDSCH (DL DCI format) or a PUSCH (UL DCI format) transmission. A DCI format includes cyclic redundancy check (CRC) bits in order for a UE (e.g., the UE 116) to confirm a correct detection. A DCI format type is identified by a radio network temporary identifier (RNTI) that scrambles the CRC bits. For a DCI format scheduling a physical downlink shared channel (PDSCH) or a PUSCH for a single UE with RRC connection to a gNB (e.g., the BS 102), the RNTI is a cell RNTI (C-RNTI) or another RNTI type such as a modulation and coding scheme-cell RNTI (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH receptions as determined by an associated search space set.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in v17.6.0 of REF2 or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,ƒ}^{μ} in a frame with number n_{ƒ} if (n_{ƒ}·Nₛₗₒₜ^{frame,μ}+n_{s,ƒ}^{μ}−oₛ) mod kₛ=0. The UE monitors PDCCH candidates for search space set s for Tₛ consecutive slots, starting from slot n_{s,ƒ}^{μ}, and does not monitor PDCCH candidates for search space set s for the next kₛ−Tₛ consecutive slots. The UE determines CCEs for monitoring PDCCH according to a search space set based on a search space equation as described in v17.6.0 of REF3.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in v17.6.0 of REF2, so that the DCI size limit would not be exceeded.

For each scheduled cell, the UE is not required to monitor on the active DL BWP with SCS configuration u of the scheduling cell more than min (M_{PDCCH}^{max,slot,μ}, M_{PDCCH}^{total,slot,μ}) PDCCH candidates or more than min(C_{PDCCH}^{max,slot,μ}, C_{PDCCH}^{total,slot,μ}) non-overlapped CCEs per slot, wherein M_{PDCHH}^{max,slot,μ} and C_{PDCCH}^{max,slot,μ} are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in v17.6.0 of REF3.

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the limits/maximum per slot for scheduling on the primary cell mentioned herein, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in v17.6.0 of REF3.

For same cell scheduling or for cross-carrier scheduling where a scheduling cell and scheduled cells have DL BWPs with same SCS configuration μ, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in v17.6.0 of REF3 and v17.6.0 of REF4.

MIMO technologies have a key role in boosting system throughput both in NR and LTE and such a role will continue and further expand in the future generations of wireless technologies. For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

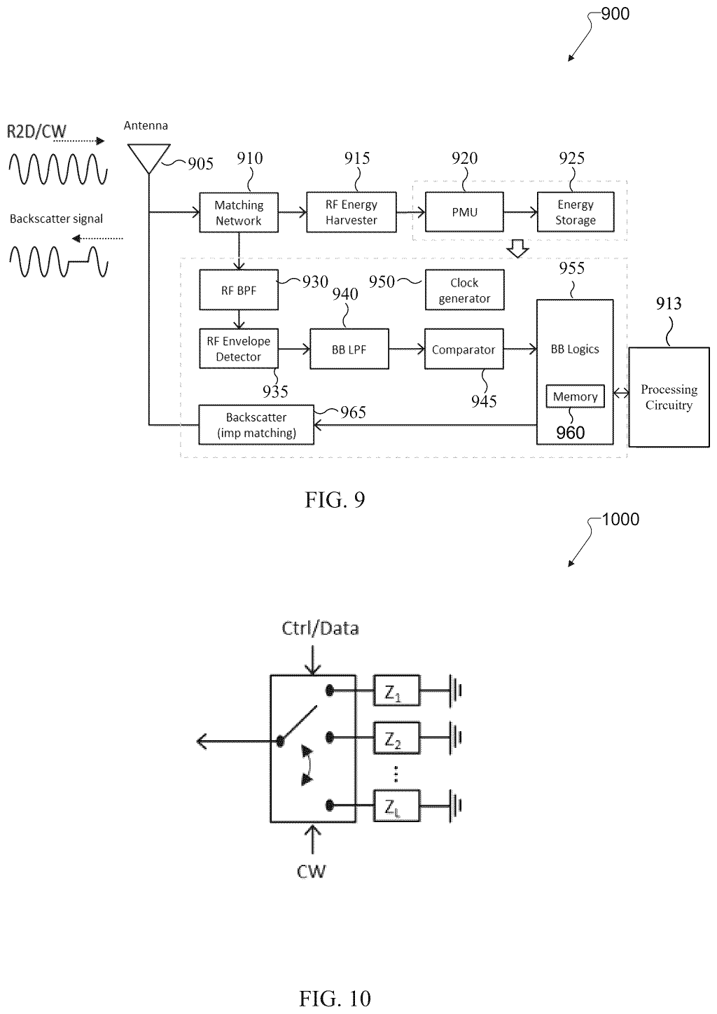

FIG. 9 illustrates a diagram of an example type-1 backscatter structure 900 for IoT devices according to embodiments of the present disclosure. For example, type-1 backscatter structure 900 can be implemented by any of the UEs 111-116 of FIG. 1, or may be devices with fewer components and functionality than a UE. This example is for illustration only and other embodiments can be used without departing from the scope of the present disclosure.

As shown in FIG. 9, the type-1 backscatter structure 900 for IoT devices includes an antenna 905, a matching network 910, a RF energy harvester 915, a phasor measurement unit (PMU) 920, an energy storage 925, a RF bandpass filter (BPF) 930, a RF envelope detector 935, a baseband (BB) lowpass filter (LPF) 940, a comparator 945, a clock generator 950, a BB logistics 955, a memory 960, backscatter (imp matching) 965, and processing circuitry 913.

In various embodiments, the processing circuitry 913, which may be a full-powered processor, such as included in UE 116, a lower-power microprocessor or microcontroller, an application specific integrated circuit (ASIC), or logic circuitry. The processing circuitry 913 can control the overall operation of the IoT device including determination of reception and/or transmission timing. The processing circuitry 913 may be powered via energy storage and power management 905. The signal receiving and transmitting processing circuitry included in the IoT devices, such as RF BPF 906, a RF envelope detector 908, a comparator/analog to digital converter (ADC) 910, a baseband 912, a LO 918, a mixer 920, a modulator (impedance matching) 922, may be referred to as a transceiver, which may use separate antennas for reception and transmission, respectively, or may use a common antenna, such as antenna 905 for transmission and reception. One or more implementations described herein further include other implementation variations such as separate Tx-Rx antennas vs common Tx-Rx antenna, use of a sensor, etc. The implementations should be understood as an example and not as a restriction.

FIG. 10 illustrates a diagram of an example impedance matching circuit according to embodiments of the present disclosure. For example, impedance matching circuit 1000 can be implemented in any of the IoT device described herein. This example is for illustration only and other embodiments can be used without departing from the scope of the present disclosure.

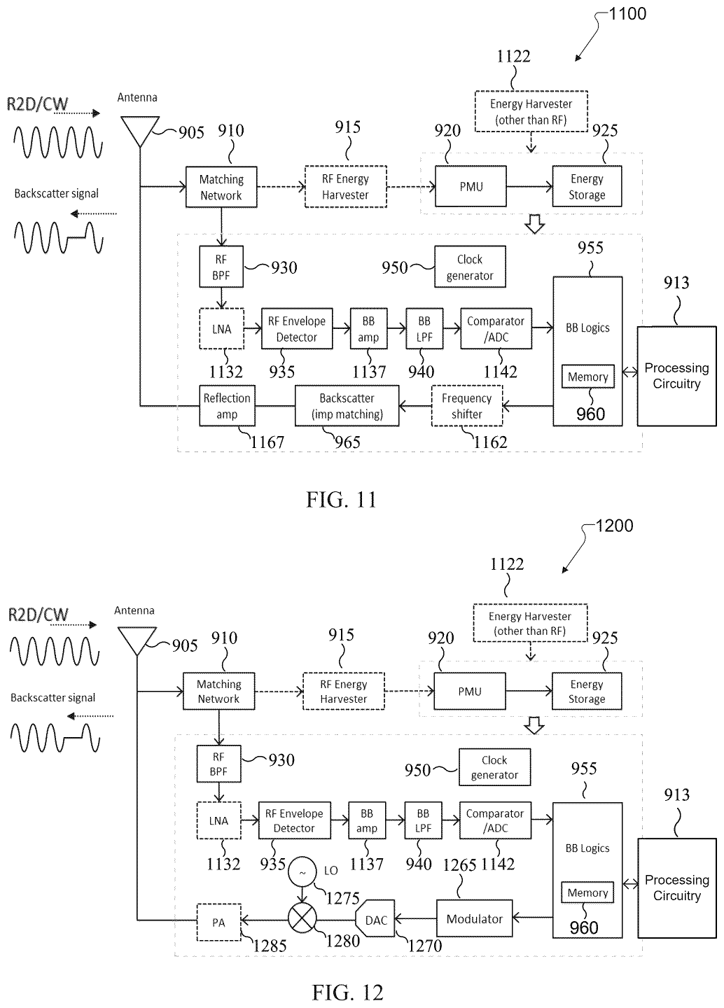

FIG. 11 illustrates a diagram of an example type-2a backscatter structure 1100 for IoT devices according to embodiments of the present disclosure. For example, backscatter structure 1100 can be implemented by any of the UEs 111-116 of FIG. 1, such as the UE 111, or may be devices with fewer components and functionality than a UE. This example is for illustration only and other embodiments can be used without departing from the scope of the present disclosure.

As shown in FIG. 11, the type-2a backscatter structure 1100 includes an antenna 905, a matching network 910, a RF energy harvester 915, a PMU 920, an energy storage 925, an energy harvester (other than RF) 1122, a RF BPF 930, a low noise amplifier (LNA) 1132, a RF envelope detector 935, a BB amp 1137, a BB LPF 940, a comparator/ADC 1142, a clock generator 950, a BB logistics 955, a memory 960, a frequency shifter 1162, backscatter (imp matching) 965, a reflection amp 1167, and processing circuitry 913.

FIG. 12 illustrates a diagram of an example type-2b backscatter structure 1200 for IoT devices according to embodiments of the present disclosure. For example, backscatter structure 1200 can be implemented by any of the UEs 111-116 of FIG. 1, such as the UE 112, or may be devices with fewer components and functionality than a UE. This example is for illustration only and other embodiments can be used without departing from the scope of the present disclosure.

As shown in FIG. 12, the type-2b backscatter structure 1200 includes an antenna 905, a matching network 910, a RF energy harvester 915, a PMU 920, an energy storage 925, an energy harvester (other than RF) 1122, a RF BPF 930, a LNA 1132, a RF envelope detector 935, a BB amp 1137, a BB LPF 940, a comparator/ADC 1142, a clock generator 950, a BB logistics 955, a memory 960, a modulator 1265, a digital to analog converter (DAC) 1270, a local oscillator (LO) 1275, a mixer 1280, a PA 1285, and processing circuitry 913.

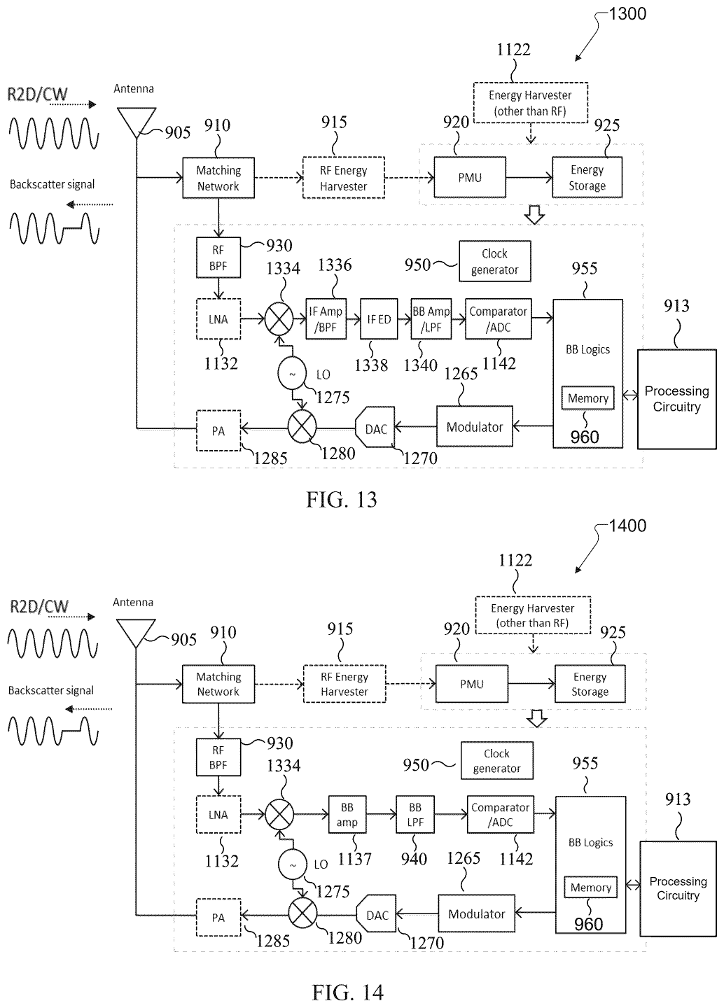

FIG. 13 illustrates a diagram of an example type-2b structure 1300 for IoT devices according to embodiments of the present disclosure. For example, structure 1300 can be implemented by any of the UEs 111-116 of FIG. 1, such as the UE 113, or may be devices with fewer components and functionality than a UE. This example is for illustration only and other embodiments can be used without departing from the scope of the present disclosure.

As shown in FIG. 13, the type-2b structure 1300 includes an antenna 905, a matching network 910, a RF energy harvester 915, a PMU 920, an energy storage 925, an energy harvester (other than RF) 1122, a RF BPF 930, a LNA 1132, a mixer 1334, an IF Amp/BPF 1336, an IF envelope detector (ED) 1338, a BB amp/LPF 1340, a comparator/ADC 1142, a clock generator 950, a BB logistics 955, a memory 960, a modulator 1265, a DAC 1270, a LO 1275, a mixer 1280, a PA 1285, and processing circuitry 913.

FIG. 14 illustrates a diagram of an example type-2b structure 1400 for IoT devices according to embodiments of the present disclosure. For example, backscatter structure 1400 can be implemented by any of the UEs 111-116 of FIG. 1, such as the UE 114, or may be devices with fewer components and functionality than a UE. This example is for illustration only and other embodiments can be used without departing from the scope of the present disclosure.

As shown in FIG. 14, the type-2b structure 1400 includes an antenna 905, a matching network 910, a RF energy harvester 915, a PMU 920, an energy storage 925, an energy harvester (other than RF) 1122, a RF BPF 930, a LNA 1132, a mixer 1334, a BB amp 1137, a BB LPF 940, a comparator/ADC 1142, a clock generator 950, a BB logistics 955, a memory 960, a modulator 1265, a DAC 1270, a LO 1275, a mixer 1280, a PA 1285, and processing circuitry 913. Several different types of A-IoT devices can be regarded as following.
Device 1: ˜1 μW peak power consumption, has energy storage, initial sampling frequency offset (SFO) up to 10× ppm, neither R2D nor D2R amplification in the device. The device's D2R transmission is backscattered on a carrier wave provided externally.
Device 2a: ≤a few hundred μW peak power consumption, has energy storage, initial sampling frequency offset (SFO) up to 10× ppm, both R2D and/or D2R amplification in the device. The device's D2R transmission is backscattered on a carrier wave provided externally.
Device 2b: ≤a few hundred μW peak power consumption, has energy storage, initial sampling frequency offset (SFO) up to 10× ppm, both R2D and/or D2R amplification in the device. The device's D2R transmission is generated internally by the device.

The devices may operate in frequency division duplexing (FDD) spectrum or time division duplexing (TDD) spectrum, which may be licensed or unlicensed.

In the following, reference architectures for the device types herein are provided, which should be understood as an example and not as a restriction.

With reference to FIG. 9, an example Type-1 backscatter device structure according to the disclosure is shown.

The RF energy harvester 915 converts RF signal to DC power and supplies to the device. Either a R2D signal or an externally provisioned CW signal for backscattering can be utilized for RF energy harvesting. The CW is externally provided from a gNB or a dedicated source. The source of CW signal, e.g., either a gNB or a dedicated node, may or may not be agnostic to A-IoT devices. The harvested energy, e.g., using a rectifier, can be stored using a capacitor, super-capacitor, or, generally speaking, an energy storage. Antenna could be either shared or separate for RF energy harvester and receiver/transmitter. Matching network 910 is to match impedance between antenna and other components. Power management unit (PMU) 920 manages storing energy to energy storage from energy harvester and suppling power to active component blocks which needs power supply. Clock generator 950 provides required clock signal(s).

The R2D signal is demodulated using a low complexity envelop detector and comparator, whose output is provided as an input to the baseband circuit. Given the low-power and low-complexity requirements of the Type-1 backscatter device, an RF envelop detection can be a viable solution for a receiver architecture, compared to a heterodyne architecture with IF envelope detection or a homodyne architecture with baseband envelope detection, which require LO and frequency mixer for frequency down-conversion. The input RF signal passes through an RF band-pass filter (BPF) 930 for an adjacent channel interference suppression, and then the filtered RF signal is directly converted into a baseband using an RF envelop detector 935, followed by a baseband low-pass filter (LPF) 940 for filtering out harmonics and high frequency components, and an n-bit comparator, where n can be 1, 2, 4, 8, . . . . The use of filters, e.g., BPF only, LPF only, or both, can be an implementation choice.

For the D2R backscatter transmission, any of the following can be used:
Case 1) CW is provisioned at DL spectrum and backscattered, i.e., CW @ DL spectrum, D2R backscattering @ DL spectrum.
Case 2) CW is provisioned at UL spectrum and backscattered, i.e., CW @ UL spectrum, D2R backscattering @ UL spectrum.
Case 3) CW is provisioned at DL spectrum, frequency shifted to UL spectrum, and then backscattered, i.e., CW @ DL spectrum, D2R backscattering @ UL spectrum.

In one example, Case 1) or Case 2) is evaluated for device 1, i.e., CW and D2R backscattering on the same frequency and, therefore, a frequency shifter (FS) is not required.

With reference to FIG. 10, an example impedance matching circuit for backscatter device D2R modulation according to the disclosure is shown.

The followings are simple examples of impedance matching operations:
Open circuit: Full reflection of the received CW signal in the same phase. This can be used for on-off keying (OOK) modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log₂(L) bits per symbol ASK modulation.

Depending on the matched load impedance, the matching circuit can backscatter the incoming CW signal with different reflection coefficients in both amplitude and phase. In general, ASK/PSK/frequency shift keying (FSK) may be supported using an impedance matching circuit. As a simplest modulation scheme, OOK may be evaluated. The device may indicate its modulation capability or impedance matching capability to the network, or certain requirement may be predefined in the specification of system operation.

With reference to FIG. 11, an example device 2a architecture based on RF envelop detection according to the disclosure is shown.

The device 2a may share similar structure at large with device 1 as the D2R transmission is still based on backscattering of an externally provided CW, while the device 2a may differ from device 1 from the following aspects.

The device 2a has ≤a few hundred μW peak power consumption and both R2D and/or D2R amplification in the device. In this case, alternative to the RF energy harvesting from a R2D signal or an externally provided CW signal, other renewable energy sources, e.g., solar, thermal, kinetic, etc., may be provided for energy harvesting. The presence of a certain energy harvesting capability from a certain renewable energy source may be expected for system design point of view. The use of energy harvesters, e.g., RF energy harvester only, other energy harvester only, or both, can be an implementation choice.

The device 2a may be equipped with both R2D and/or D2R amplification in the device. Given the power consumption requirement, i.e., ≤a few hundred μW, the R2D/D2R amplification for device 2a may be based on an architecture that is different from the typical power amplifier (PA) and low noise amplifier (LNA). In some example low-power/complexity architectures for forward amplifier for reader-to-device (R2D) reception and reflection amplifier for device-to-reader (D2R) transmission, a single bipolar transistor terminated with microstrips may be used. The receiver amplification can be either RF amplification prior to the envelop detector, baseband amplification after the envelop detector, or both, which is an implementation choice. In one example, a reflection amplifier is used for both R2D reception and D2R transmission, and LNA may or may not exist. In another example, a reflection amplifier is used for D2R transmission only and LNA is used for R2D reception amplification.

One additional difference of device 2a compared to device 1 may be a use of a FS. With a few hundred μW peak power consumption, some low-power LO architectures with a frequency mixer can be evaluated for Case 3). With FS, it can be expected that the CW is provided in a frequency different than the UL carrier frequency. Taking into account that the A-IoT devices are targeting for low complexity and low power consumption, the following options can be evaluated as an example method for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the UL carrier frequency; In this case, no frequency shifter is needed.
Use of harmonic frequencies of CW signal or intermodulation frequencies of two-tone CW signals.

The device 2a receiver architecture may be based on RF envelop detector, intermediate frequency (IF) envelop detector, i.e., heterodyne receiver, or homodyne receiver with zero IF, as exemplified for device 2b.

With reference to FIG. 12, an example device 2b architecture based on RF envelop detection according to the disclosure is shown.

With reference to FIG. 13, an example device 2b architecture based on heterodyne/IF-ED receiver according to the disclosure is shown.

With reference to FIG. 14, an example device 2b architecture based on homodyne/zero-IF receiver according to the disclosure is shown.

The device 2b shares similar structure at large with the device 2a other than the D2R signal is internally generated using LO rather than backscattering the externally provided CW. The example architecture shown in FIGS. 12-14 is based on a typical active transmitter chain, wherein the D2R data is modulated, converted to an analog signal using digital to analog converter (DAC) and, then up-converted to a UL carrier frequency using LO and frequency mixer, which is followed by an amplifier.

In FIG. 12, the R2D receiver chain is still based on the RF envelop detector as in the previous architectures. In FIG. 13, the R2D receiver chain is based on heterodyne receiver with IF envelop detector. In the heterodyne architecture, the RF signal is down converted into an intermediate frequency and then detected using an envelope detector. In FIG. 14, the R2D receiver is based on homodyne receiver, i.e., zero-IF. In the homodyne/zero-IF architecture, the RF signal is directly down converted into baseband signal and then detected using a comparator/ADC.

FIGS. 9-14 should be understood for illustration purpose only. There can be other components not explicitly shown in the figure such as switch, duplexer, and filters, or some components may be replaced to different options. Also, the devices can operate both in TDD and FDD spectrum, either licensed or unlicensed, and, depending on the operating spectrum, the actual architectures can be different from the conceptual illustrations in the figures.

In deploying A-IoT devices, different topology options can be evaluated. The following provides examples of topology options:
Topology 1: BS⇄A-IoT device
   An A-IoT device directly and bidirectionally communicates with a basestation. The communication between the basestation and the A-IoT device includes A-IoT data and/or signalling. This topology includes the possibility that the BS transmitting to the A-IoT device is a different from the BS receiving from the A-IoT device.
Topology 2: BS⇄intermediate node⇄Ambient IoT device
   An A-IoT device communicates bidirectionally with an intermediate node between the device and basestation. In this topology, the intermediate node can be a relay, IAB node, UE, repeater, etc. which is capable of A-IoT. The intermediate node transfers A-IoT data and/or signalling between BS and the A-IoT device. The intermediate node is referred to as I-node in this disclosure.
Topology 3: BS⇄assisting node⇄Ambient IoT device⇄BS.
   An A-IoT device transmits data/signalling to a basestation, and receives data/signalling from the assisting node; or the A-IoT device receives data/signalling from a basestation and transmits data/signalling to the assisting node. In this topology, the assisting node can be a relay, IAB, UE, repeater, etc. which is capable of A-IoT.
Topology 4: UE⇄Ambient IoT device
   An A-IoT device communicates bidirectionally with a UE. The communication between UE and the A-IoT device includes A-IoT data and/or signalling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be expected that the deployment of A-IoT can be on new sites without an assumption of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

Any operations performed by BS in this disclosure can be also performed by I-node instead of the BS, and each of or part of interfaces are transparent to the A-IoT devices. An entity directly communicating with a device, or tag, is collectively termed as a reader, which can be for example, e.g., a gNB, a UE, or an intermediate/assisting node of any type such as relay, repeater, UE, or gNB (e.g., the BS 102).

A physical channel for reader to device transmission is referred to as a physical reader to device (R2D) channel (PRDCH), and a physical channel for device to reader transmission is referred to as a physical device to reader (D2R) channel (PDRCH) in this disclosure.

For PRDCH and PDRCH transmission, a timing acquisition signal, e.g., a preamble, is included at least for timing acquisition and for indicating the start of the transmission in time domain, respectively.

There may be a timing relationship between transmissions as herein:
T_{R2D_min}, T_{R2D_max}: Minimum/maximum time between a R2D transmission and the corresponding D2R transmission following it.
T_{D2R_min}, T_{D2R_max}: Minimum/maximum time between a D2R transmission and the corresponding R2D transmission following it.
T_{R2D_R2D_min}, T_{R2D_R2D_max}: Minimum/maximum time between two different consecutive R2D transmissions to the same A-IoT device.
T_{D2R_D2R_min}, T_{D2R_D2R_max}: Minimum/maximum time between two different consecutive D2R transmissions from the same A-IoT device.

Given the low complexity and the low power consumption requirements for A-IoT devices, it is apparent that the oscillators equipped with A-IoT devices will be significantly subpar to that equipped with a normal NR UE. It is therefore impractical to expect a precise timing capability for A-IoT devices as it is usually expected for normal NR UEs. Furthermore, given that A-IoT devices are powered by harvesting energy, the device maybe running out of power time to time and, thereby, loosing timing, i.e., lacking timing maintaining capability.

One main use case of A-IoT is inventory, e.g., asset identification and tracking, while the reader may not have a prior knowledge of devices in its proximity. Therefore, embodiments of the present disclosure recognize that there is a need to define procedures and methods for device identification via random access.

The A-IoT use cases may be mainly related to DO-DTT or DT traffic types, rather than the device has its own traffic to initiate the channel access by itself. Furthermore, the A-IoT devices may be passive backscatter type. Therefore, embodiments of the present disclosure further recognize that there is a need to define procedures and methods for transmitting triggering message to initiate device identification procedure.

Without a prior knowledge on the density of unidentified devices in the proximity, embodiments of the present disclosure further recognize that there is a need to define procedures and methods for efficiently multiplexing random access transmissions from unknown number of devices.

An acknowledge message may need to be provided for the confirmation of successfully received random access message, which may also provide scheduling information for the subsequent device to reader transmission. Furthermore, given a large number of devices, the acknowledge message transmission needs to be designed in an efficient manner. Therefore, there is another need to define procedures and methods for providing acknowledge message in response to random access message in an efficient manner.

The disclosure relates to a communication system. The disclosure relates to defining functionalities and procedures for communication with A-IoT devices which may be lacking a precise timing capability and may operate in a passive or an active communication mode.

The disclosure relates to defining functionalities and procedures for device identification via random access.

The disclosure further relates to defining functionalities and procedures for transmitting triggering message to initiate device identification procedure.

The disclosure further relates to defining functionalities and procedures for efficiently multiplexing random access transmissions from unknown number of devices.

The disclosure further relates to defining functionalities and procedures for providing acknowledge message in response to random access message in an efficient manner.

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Embodiments of the disclosure for communication with A-IoT devices, which may be lacking a precise timing capability and may operate in a passive/active communication mode, are summarized in the following and are fully elaborated further herein.
Method and apparatus for defining functionalities and procedures for device identification via random access.
Method and apparatus for defining functionalities and procedures for transmitting triggering message to initiate device identification procedure.
Method and apparatus for defining functionalities and procedures for efficiently multiplexing random access transmissions from unknown number of devices.
Method and apparatus for defining functionalities and procedures for providing acknowledge message in response to random access message in an efficient manner.

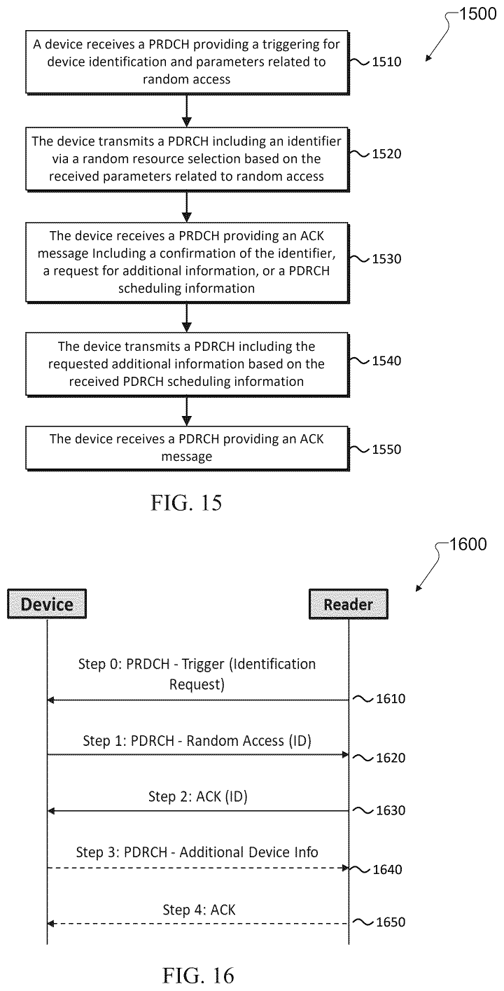

FIG. 15 illustrates a flowchart of an example procedure 1500 for triggered random access for device identification according to embodiments of the present disclosure. For example, procedure 1500 can be performed by any of the devices described herein. This example is for illustration only and other embodiments can be used without departing from the scope of the present disclosure.

The procedure begins in 1510, a device receives a PRDCH providing a triggering for device identification and parameters related to random access. In 1520, the device transmits a PDRCH including an identifier via a random resource selection based on the received parameters related to random access. In 1530, the device receives a PRDCH providing an acknowledgement (ACK) message including a confirmation of the identifier, a request for additional information, or a PDRCH scheduling information. In 1540, the device transmits a PDRCH including the requested additional information based on the received PDRCH scheduling information. In 1550, the device receives a PDRCH providing an ACK message.

FIG. 16 illustrates a flowchart of an example procedure 1600 for triggered random access for device identification according to embodiments of the present disclosure. For example, procedure 1600 can be performed by any of the devices described herein and any of the readers described herein. This example is for illustration only and other embodiments can be used without departing from the scope of the present disclosure.

The procedure begins in 1610, a reader transmits a PRDCH, which triggers identification request to a device. In 1620, the device transmits a PDRCH via random access providing temporary device ID, e.g., random number, to the reader. In 1630, the reader transmits an ACK by confirming the ID received in 1620 to the device. In 1640, the device may transmit a PDRCH-additional device information to the reader. In 1650, the reader may transmit an ACK to the device.

The general principle for triggered random access for device identification includes a physical reader to device channel (PRDCH) transmission by a reader providing a triggering for the process and the related parameters, and a physical device to reader channel (PDRCH) transmission by a device providing its identifier via a random resource selection based on the received parameters.

With to reference to FIG. 15, an example flowchart of a device to perform triggered random access for device identification according to the disclosure is shown.

With reference to FIG. 16, an example signal flow of triggered random access for device identification according to the disclosure is shown.

In Step 0, a device receives a PRDCH providing a triggering for device identification and parameters related to random access.

The triggering can be a unicast message addressed to a particular device by indicating a device ID, a multicast message addressed to a group of devices by indicating a device group ID, or a broadcast message to any devices in the proximity.

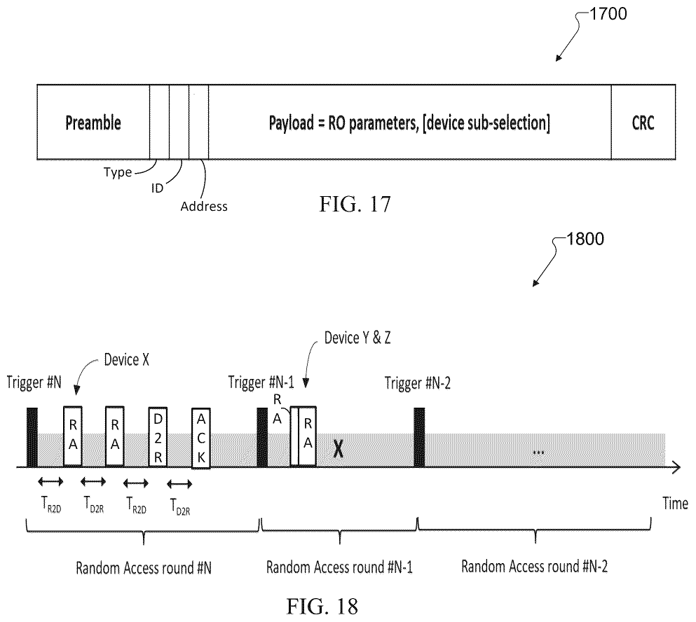

FIG. 17 illustrates a diagram of an example PRDCH frame structure 1700 according to embodiments of the present disclosure. For example, PRDCH frame structure 1700 can be transmitted by any of the reader devices described herein. This example is for illustration only and other embodiments can be used without departing from the scope of the present disclosure.

The PRDCH transmission providing a triggering message may include one or more of:
Reader ID which can be uniquely identify the reader, e.g., a reader device ID, a random number, or a Cell ID.
Parameters related to power control: transmission power of a PDRCH preamble or any pathloss reference signal, e.g., synchronization signal block (SSB), beacon, any RSs, target reception power, pathloss scaling factor, a power ramping step in dB for re-attempts.
Parameters related to random access resource configuration
   A number of time slots for random access, whose duration is predefined in the specifications of system operation or indicated in the triggering message.
   A frequency domain resources. In one example, it can be a number of frequency domain resources, wherein the resource can be a sub-carrier, a PRB, a unit frequency amount, or frequency ranges. As an example, a device may randomly select a frequency resource from the number of resources. In another example, it can be a number of frequency shifts, wherein the shifts can be indicated by ±Δ Hz, ±integer multiples of a unit amount of a frequency, or a parameter of a line code, such as a number of subcarrier cycles per symbol.
   There may be an indication of available or prohibited time slots/frequency resources/shifts for random access, e.g., using a mask or a bitmap of a size equal to the number of time slots. The mask/bitmap may be provided separately for each frequency resource/shift, or commonly.
Parameters related to random access
   Medium access probability, which may be applied for the given time slots, or per time slot in an individual manner. In one example, the access probability may be 1.
Parameters related to identifier to include in PDRCH transmission. In one example, parameters are related to random number generation such as an interval to draw a random number, e.g., [0, 2^{N}−1], wherein N is indicated. In another example, indication is provided for a type of identifier, such as device product code, e.g., PC, XPC, EPC, or a random number, and such as full format or a shortened format.
Parameters related to PDRCH
   Transmission duration, e.g., in number of symbols or chips, payload size
   Frequency resources such as a particular sub-carrier, PRB, or frequency range for transmission. In another example, a particular frequency shift amount for D2R transmission such as by ±Δ Hz, ±integer multiples of a unit amount of a frequency, or a parameter of a line code, such as a number of subcarrier cycles per symbol.
   MCS or a parameter of a line code, such as a number of subcarrier cycles per symbol.
   Attachment of preamble, midamble, postamble, and their format, e.g., long or short format, if more than one formats are supported.
   Attachment of CRC, and/or CRC size.
   Modulation type such as OOK-1, OOK-4, BPSK, QPSK, FSK, ASK with orders.
   Coding type such as indicator for Manchester coding, FM0, or Miller coding.
Parameters related to device selection
   A particular device ID
   A particular device group ID
      A device may be assigned with a unique device group ID, apart from a device ID.
      A device ID may be comprised of two parts; first part a device group ID and second part a device ID within the group. In this case, the first part of the device ID is indicated.
      mod (device ID, K)=L. In this case, K and L are indicated. In one example, L is fixed, e.g., zero, and only K is indicated.
   All devices, e.g., by indicating NULL or some predefined codepoint for addressing the target device or device groups in the PRDCH transmission.
Other parameters
   Maximum number of allowed random access transmissions
   Response monitoring window after transmitting the random access
   Prohibit timer after a failed random access attempt
   Allowance of D2R power amplification
   System/channel/occupied BW
   Sub-carrier spacing
   Parameters related to the carrier wave (CW), e.g., CW bandwidth, frequency, single-tone or multi-tone. PRDCH to CW power offset.

With reference to FIG. 17, an example frame structure for PRDCH transmission providing a trigger message according to the disclosure is shown.

The TYPE field may indicate a certain codepoint, which may be predefined in the specifications of system operation, indicating that the corresponding PRDCH transmission is for triggering random access for device identification. The ID field may indicate the transmitter ID, i.e., a reader ID. The ADDR field may provide parameters related to device selection. The Payload field may provide any subset of parameters from the list of information elements herein.

In Step 1, the device transmits a PDRCH including an identifier via a random resource selection based on the received parameters related to random access.

The device transmits PDRCH by randomly selecting a time and/or frequency resource from the set of random access resources indicated by PRDCH. If K time slots and M frequency resources/shifts are configured, the device selects a resource from K·M resources. If an allowance/prohibition mask is provided, the device selects a resource from allowed resources.

The device may draw a Bernoulli random variable using an access probability PA. If an outcome is positive, the device randomly selects one resource from the set of resources and transmits PDRCH. If the outcome is negative, the device skips the current random access round. In another example, the access probability is applied per resource in the random access round. For example, in each time slot, the device draws a Bernoulli random variable and decides whether to access the medium or not. In yet another example, for a given resource, e.g., time slot, the device draws a uniform discrete random variable from a certain range, e.g., [0, 2^{N}−1] or [1, 2^{N}], and, if the drawn random variable is n, whose value is predefined, e.g., zero or 1, or indicated to the device, the device attempts random access.

In the case of a failed random access, e.g., the device does not receive ACK after transmitting PDRCH, the access probability may be decreased. In one example, the access probability P_{A} is multiplied by δ (≤1) for each failed random access, i.e., P_{A}^{NEW}=δ·P_{A}. In another example, the value N is incremented by one for each failed random access, i.e., N^{new}=N+1. In another example, a new P_{A} or N value is provided by PRDCH trigger message in every random access round.

There may be an increase of PDRCH transmission power by the indicated (or predefined) power ramping amount for subsequent retransmissions, which is upper bounded by the device's maximum amplification or transmission power level, or an upper limit provided by the reader. In one example, the upper bound is a minimum of maximum amplification or transmission power level and the upper limit provided by the reader.

Once a device completes the procedure, its state is changed to ‘identified’ and it does not participate the identification process unless its ID is explicitly addressed in the PRDCH trigger message. In another example, there is a validity timer such that the identification is valid for a given time duration, during which the device does not participate the identification process unless explicitly addressed. The timer may be predefined or indicated to the device.

The PDRCH includes device ID as requested in the PRDCH or as predefined in the specifications of system operation. The ID provided in the PDRCH transmission for random access can be a random number, or related to device code, such as PC, XPC, EPC, in a full or shortened format.

The PDRCH includes may include preamble, control field, payload, and CRC. In one example, the PDRCH for step 1 transmission does not include payload and/or CRC, if the device ID is provided in the control field. In another example, the CRC is present if the payload size is greater than a certain threshold and absent if not. The TYPE field may indicate a certain codepoint, which may be predefined in the specifications of system operation, indicating that the corresponding PDRCH transmission is for random access for device identification. The ID field may indicate the transmitter ID, i.e., a device ID. The ADDR field may indicate the intended reader ID.

FIG. 18 illustrates a timeline 1800 of an example sequential device identification process according to embodiments of the present disclosure. For example, timeline 1800 can be followed by any of the readers described herein and any of the devices described herein. This example is for illustration only and other embodiments can be used without departing from the scope of the present disclosure.

With reference to FIG. 18, a sequential device identification process via random access according to the disclosure is shown.

In the sequential device identification process via random access, device identification is performed for one device in one random access round. The figure is illustrated for time domain operation. It can be understood that the operation can be both in time and frequency domain, i.e., the Step 1 PDRCH transmission may involve a random time/frequency resource selection.

As illustrated in the figure, a PRDCH transmission providing a trigger indicates a start of a random access round. In one example, the time intervals between two consecutive triggers are fixed. In another example, the time intervals between two consecutive triggers are variable. For instance, a reader may early terminate the random access round, if no PDRCH transmission is successfully received, by transmitting the next PRDCH providing a trigger early.

In one example, the trigger message may provide a current random access round index as the round progresses, i.e., N, N−1, N−2, . . . , 1. In another example, the trigger message provides the total number of random access rounds, i.e., N, repeatedly.

A device randomly determine the medium access, for instance, using one of the following methods:
The device may draw a Bernoulli random variable using an access probability PA. If an outcome is positive, the device randomly selects one random access round for random access. If the outcome is negative, the device does not participate in the current set of random access rounds.
In another example, the access probability is applied per random access round. For example, in each round, the device draws a Bernoulli random variable and decides whether to access the medium or not.
In yet another example, for a given round, the device draws a uniform discrete random variable from a certain range, e.g., [0, 2^{N}−1] or [1, 2^{N}], and, if the drawn random variable is n, whose value is predefined, e.g., zero or 1, or indicated to the device, the device attempts random access in the given random access round.

The random access transmission may follow the preceding trigger message no earlier than T_{R2D} time interval. The ACK message may follow the preceding trigger message no earlier than T_{D2R} time interval. The subsequent PDRCH transmission may follow the preceding ACK message no earlier than T_{R2D} time interval. The subsequent ACK message may follow the preceding trigger message no earlier than T_{D2R} time interval.

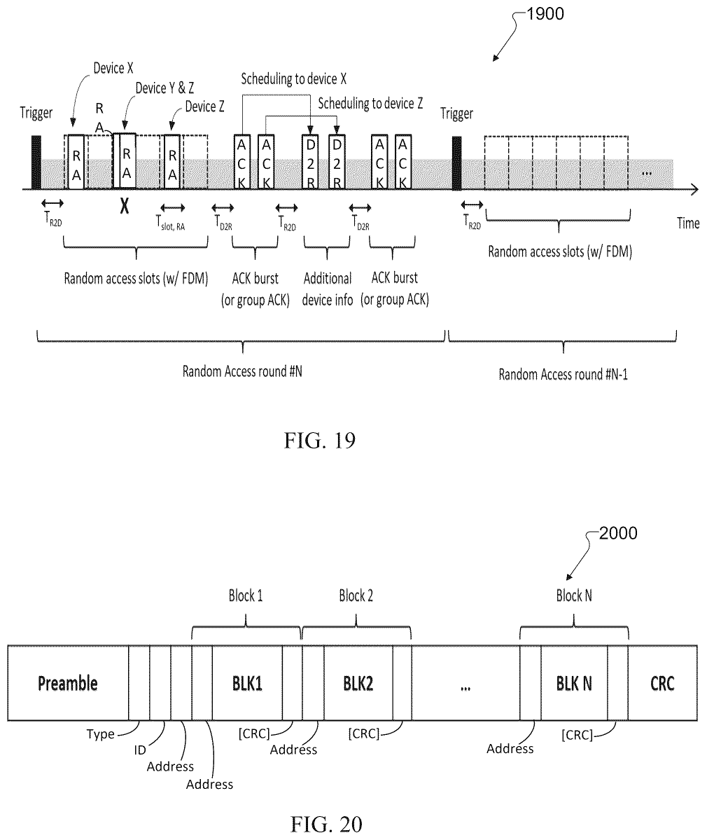

FIG. 19 illustrates a timeline 1900 of an example multiplexed identification process according to embodiments of the present disclosure. For example, timeline 1900 can be followed by any of the readers described herein and any of the devices described herein. This example is for illustration only and other embodiments can be used without departing from the scope of the present disclosure.

With reference to FIG. 19 a multiplexed device identification process via random access according to the disclosure is shown.

The figure is illustrated for time domain operation. It can be understood that the operation can be both in time and frequency domain, i.e., the Step 1 PDRCH transmission may involve a random time/frequency resource selection.

As in the previous sequential identification example, a PRDCH transmission providing a trigger indicates a start of a random access round, the time intervals between two consecutive triggers may be fixed or variable, and the trigger message may provide a current random access round index as the round progresses or provides the total number of random access rounds repeatedly.

The trigger message provides a number of time slots and/or frequency resources following the trigger message no earlier than T_{R2D} time interval. The random access slot duration, T_{slot, RA} may be predefined or indicated to the device in the trigger message.

A device randomly determine the medium access, for instance, using one of the following methods:
The device may draw a Bernoulli random variable using an access probability P_{A}. If an outcome is positive, the device randomly selects one random access round for random access. For the given random access round, the device randomly selects one time and/or frequency resource from the set of resources. If the outcome is negative, the device does not participate in the current set of random access rounds.
In another example, the access probability is applied per random access round. For example, in each round, the device draws a Bernoulli random variable and decides whether to access the medium or not. If the device decided to access, for the given random access round, the device randomly selects one time and/or frequency resource from the set of resources.
In yet another example, for a given round, the device draws a uniform discrete random variable from a certain range, e.g., [0, 2^{N}−1] or [1, 2^{N}], and, if the drawn random variable is n, whose value is predefined, e.g., zero or 1, or indicated to the device, the device attempts random access in the given random access round by randomly selecting one time and/or frequency resource from the set of resources.
In yet another example, for a given time slot in a given random access round, the device draws a uniform discrete random variable from a certain range, e.g., [0, 2^{N}−1] or [1, 2^{N}], and, if the drawn random variable is n, whose value is predefined, e.g., zero or 1, or indicated to the device, the device attempts random access.

The random access from multiple devices occurs in a burst manner over a number of consecutive time slots. In one example, the length of each time slot includes PDRCH transmission duration for random access and guard time. In another example, the length of each time slot is equal to PDRCH transmission duration for random access, and there is a separate guard time provided between time slots. In yet another example, the reader transmits a certain timing reference signal, e.g., preamble, synchronization signal, etc., in the beginning of each time slot, and the PDRCH transmission for random access follows after a certain time interval, e.g., T_{R2D}.

FIG. 20 illustrates a diagram of an example PRDCH frame structure 2000 according to embodiments of the present disclosure. For example, PRDCH frame structure 2000 can be transmitted by any of the reader devices described herein. This example is for illustration only and other embodiments can be used without departing from the scope of the present disclosure.

In Step 2, The device receives a PRDCH providing an ACK message Including a confirmation of the identifier, a request for additional information, or a PDRCH scheduling information.

The embodiments herein can apply to both the sequential and multiplexed device identification processes.

In one example, there may be more than one devices access the medium in the same random access round and none of them may be correctly received by the reader.

The ACK message may be transmitted by the reader T_{D2R} time after the end of random access slots. There may be a certain time interval that a device awaits for the ACK response from the reader, which may be predefined or indicated to the device in the trigger message. If a device does not receive a following ACK message within the time interval, the device determines that the random access is failed. In another example, if the device receives another triggering message, while awaiting for ACK, the device determines that the random access is failed.

In one example, the ACK message is provided individually for each successfully received PDRCH random access message in a burst manner. When one or more ACK messages are transmitted in a burst manner, there may be a time gap, e.g., T_{R2D_R2D}, between the ACK transmissions. Alternatively, there may be no time gap between the consecutive ACK transmissions. In another example, a group ACK message is provided for a number of successfully received PDRCH random access messages from the preceding one or more random access slots.

In one example, there may be a certain association between the time/frequency resource for PDRCH random access transmission and the time/frequency resource for PRDCH ACK message reception. For instance, the time slot index for PDRCH random access transmission determines the timing of an ACK reception in the burst of ACKs, or a block index in the group ACK message. Similarly, the frequency shift applied for PDRCH random access transmission or frequency channel selected for PDRCH random access transmission determines the frequency resource of the ACK reception.

In one example, a group ACK message has a fixed size, L, and can include a fixed number of individual ACK messages, N_{ACK,max}. The size of group ACK, the number of individual ACK messages, and/or the size of each individual ACK message may be predefined or indicated to the devices. Therefore, even when a number of successfully received PDRCH random access messages is less or greater than N_{ACK,max}, the group ACK message size doesn't change from what is known by the device. Therefore, there can be more than one group ACK transmissions, if the number of successfully received PDRCH random access messages is greater than N_{ACK,max}. In another example, a group ACK message has a variable size, and it can include a varying number of individual ACK messages. The size of the group ACK message, individual ACK message size, and/or the number of individual ACK messages included in the group ACK may be indicated in the group ACK message itself.

With reference to FIG. 20, an example frame structure for PRDCH transmission providing a group ACK according to the disclosure is shown.

The group ACK message may be comprised of one or more of:
Preamble
TYPE: indicating group ACK.
ID: reader ID
ADDR: Sub-group ID corresponding to the ID announced in the trigger message, or NULL.
A field providing information related to the size of the group ACK message, the size of individual ACK message, and/or a number of individual ACK messages included.
A field providing parameters related to the group ACK message reception, e.g., modulation, coding, presence of CRC, FEC.
A CRC for the control field providing header information as listed herein.
A number of blocks providing a corresponding number of ACK messages.
   ADDR: individual device ID.
   Payload
   CRC per each ACK message. In one example, the presence of CRC may be dependent on the payload size of each block.
A CRC for the entire PRDCH message.

The payload of an individual ACK message, which can be provided in an individual

ACK transmission or a group ACK transmission, may provide one or more of:
The device ID received in the PDRCH transmission for random access.
Parameters related to TPC command, e.g., an index to ±Δ dB value from the random access message transmission.
Assigned device ID (if ID other than RN or product code is used for subsequent communication.)
Scheduling information for the following Step 3 PDRCH transmission, which may include one or more of:
   Parameters indicating the delay from the start or end of the reception of ACK message to the start of PDRCH transmission, which may be in a number of symbols/chips, in a number of unit time, or as an index from a set of predefined values.
   Requests on the additional device information: device type, device product code, device capability (e.g., device type, e.g., 1/2a/2b, TX power, amplification capability, FDM capability, frequency shifting capability, supported modulation schemes, etc.)
   MCS
   Frequency domain shift indicated by ±Δ Hz, ±integer multiples of a unit amount of a frequency, or a parameter of a line code, such as a number of subcarrier cycles per symbol.
   Frequency domain channel or resource information.

In Step 3, the device transmits a PDRCH including the requested additional information based on the received PDRCH scheduling information. Each device, which received Step 2 ACK message successfully, may transmit Step 3 PDRCH for providing the requested additional information. If no additional information exchange is requested or necessary, the device identification process finishes at Step 2. According to the scheduling information provided in the Step 2 ACK message, the device performs PDRCH transmission.

In Step 4, the device receives a PDRCH providing an ACK message. Design principles of Step 2 ACK transmission may be similarly applied to Step 4 ACK transmission. In one example, the Step 4 ACK message may not include payload, but includes preamble and a control field indicating the signal type being ACK, and addressed device ID. The CRC for the control field may or may not be present.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for an Internet of Things (IoT) device to communicate with a reader for device identification, the method comprising:
receiving a first physical reader-to-device channel (PRDCH), wherein:
the first PRDCH triggers a device identification procedure,
the first PRDCH provides information related to a target device indicating:
one or more device identifiers corresponding to one or more devices, respectively,
a device-group identifier corresponding to one or more devices, or
no identifier corresponding to all devices receiving the first PRDCH, and
the first PRDCH provides parameters related to random access resources including at least one of:
one or more time slots for time-division multiple access (TDMA), and
one or more frequency shifts for frequency-division multiple access (FDMA);
transmitting a first physical device-to-reader channel (PDRCH), wherein:
the first PDRCH is transmitted on a randomly selected resource based on the parameters related to the random access resources indicated in the first PRDCH, and
the first PDRCH includes a random number;
receiving a second PRDCH, wherein:
the second PRDCH includes the random number provided in the first PDRCH, and
the second PRDCH provides information related to transmission of a second PDRCH;
determining, based on reception of the second PRDCH, (i) successful transmission of the first PDRCH and (ii) transmission of the second PDRCH; and
transmitting, based on the determination of the transmission of the second PDRCH and the information related to the transmission of the second PDRCH, the second PDRCH.

2. The method of claim 1, wherein the first PRDCH further includes at least one of:
a reader identifier (ID),
a current or a remaining count of random access rounds,
information related to prevent duplicated transmissions of the first PDRCH from a same device,
a restricted set of random access resources,
parameters related to limiting transmission of the first PDRCH, and
parameters related to monitor reception of the second PRDCH.

3. The method of claim 1, wherein:
receiving the second PRDCH further comprises receiving the second PRDCH by monitoring for the second PRDCH during a monitoring time window, and
the monitoring time window is (i) predefined, (ii) indicated in the first PRDCH, or (iii) determined based on the randomly selected resource.

4. The method of claim 1, wherein the second PRDCH (i) corresponds to a number of transmissions of the first PDRCH from respective number of devices, (ii) includes random numbers provided in the number of transmissions of the first PDRCH, and (iii) provides information related to a number of transmissions of the second PDRCH.

5. The method of claim 1, wherein the information related to transmission of the second PDRCH includes at least one of:
a timing indication for transmission of the second PDRCH from the reception of the second PRDCH,
a frequency resource for transmission of the second PDRCH,
a request for additional information related to the IoT device, and
parameters related to a transmission rate of the second PDRCH.

6. The method of claim 1, wherein
the first PDRCH is not expected to be transmitted earlier than T₁ after reception of the first PRDCH,
the second PDRCH is not expected to be transmitted earlier than T₁ after reception of the second PRDCH,
the second PRDCH is not expected to be received earlier than T₂ after transmission of the first PDRCH, and
T₁ and T₂ are time durations.

7. The method of claim 1, further comprising:
after determining successful transmission of the first PDRCH, setting a state of the device as identified, and
determining not to transmit another PDRCH for device identification in response to reception of another PRDCH triggering the device identification procedure for a time duration.

8. An Internet of Things (IoT) device, comprising:
a transceiver configured to:
receive a first physical reader-to-device channel (PRDCH), wherein:
the first PRDCH triggers a device identification procedure,
the first PRDCH provides information related to a target device indicating:
one or more device identifiers corresponding to one or more devices, respectively,
a device-group identifier corresponding to one or more devices, or
no identifier corresponding to all devices receiving the first PRDCH, and
the first PRDCH provides parameters related to random access resources including at least one of:
one or more time slots for time-division multiple access (TDMA), and
one or more frequency shifts for frequency-division multiple access (FDMA);
transmit a first physical device-to-reader channel (PDRCH), wherein:
the first PDRCH is transmitted on a randomly selected resource based on the parameters related to the random access resources indicated in the first PRDCH, and
the first PDRCH includes a random number; and
receive a second PRDCH, wherein:
the second PRDCH includes the random number provided in the first PDRCH, and
the second PRDCH provides information related to transmission of a second PDRCH;
processing circuitry operably coupled to the transceiver, the processing circuitry configured to determine, based on reception of the second PRDCH, (i) successful transmission of the first PDRCH and (ii) transmission of the second PDRCH,
wherein the transceiver is further configured to transmit, based on the determination of the transmission of the second PDRCH and the information related to the transmission of the second PDRCH, the second PDRCH.

9. The IoT device of claim 8, wherein the first PRDCH further includes at least one of:
a reader identifier (ID),
a current or a remaining count of random access rounds,
information related to prevent duplicated transmissions of the first PDRCH from a same device,
a restricted set of random access resources,
parameters related to limiting transmission of the first PDRCH, and
parameters related to monitor reception of the second PRDCH.

10. The IoT device of claim 8, wherein:
the transceiver is further configured to receive the second PRDCH by monitoring for the second PRDCH during a monitoring time window, and
the monitoring time window is (i) predefined, (ii) indicated in the first PRDCH, or (iii) determined based on the randomly selected resource.

11. The IoT device of claim 8, wherein the second PRDCH (i) corresponds to a number of transmissions of the first PDRCH from respective number of devices, (ii) includes random numbers provided in the number of transmissions of the first PDRCH, and (iii) provides information related to a number of transmissions of the second PDRCH.

12. The IoT device of claim 8, wherein the information related to transmission of the second PDRCH includes at least one of:
a timing indication for transmission of the second PDRCH from the reception of the second PRDCH,
a frequency resource for transmission of the second PDRCH,
a request for additional information related to the IoT device, and
parameters related to a transmission rate of the second PDRCH.

13. The IoT device of claim 8, wherein
the first PDRCH is not expected to be transmitted earlier than T₁ after reception of the first PRDCH,
the second PDRCH is not expected to be transmitted earlier than T₁ after reception of the second PRDCH,
the second PRDCH is not expected to be received earlier than T₂ after transmission of the first PDRCH, and
T₁ and T₂ are time durations.

14. The IoT device of claim 8, wherein the processing circuitry is further configured to, after determining successful transmission of the first PDRCH, set a state of the device sets as identified and determine not to transmit another PDRCH for device identification in response to reception of another PRDCH triggering the device identification procedure for a time duration.

15. A reader, comprising:
a transceiver configured to:
transmit a first physical reader-to-device channel (PRDCH), wherein:
the first PRDCH triggers a device identification procedure,
the first PRDCH provides information related to a target device indicating:
one or more device identifiers corresponding to one or more devices, respectively,
a device-group identifier corresponding to one or more devices, or
no identifier corresponding to all devices receiving the first PRDCH, and
the first PRDCH provides parameters related to random access resources including at least one of:
one or more time slots for time-division multiple access (TDMA), and
one or more frequency shifts for frequency-division multiple access (FDMA);
receive, from an Internet of Things (IoT) device a first physical device-to-reader channel (PDRCH), wherein:
the first PDRCH is received on a randomly selected resource based on the parameters related to the random access resources indicated in the first PRDCH, and
the first PDRCH includes a random number; and
transmit a second PRDCH, wherein:
the second PRDCH includes the random number provided in the first PDRCH, and
the second PRDCH provides information related to a second PDRCH;
a processor operably coupled to the transceiver, the processor configured to determine, based on reception of the first PDRCH, successful transmission of the first PRDCH,
wherein the transceiver is further configured to receive the second PDRCH based on the information related to the second PDRCH.

16. The reader of claim 15, wherein the first PRDCH further includes at least one of:
a reader identifier (ID),
a current or a remaining count of random access rounds,
information related to prevent duplicated transmissions of the first PDRCH from a same device,
a restricted set of random access resources,
parameters related to limiting reception of the first PDRCH, and
parameters related to monitor transmission of the second PRDCH.

17. The reader of claim 15, wherein:
the transceiver is further configured to transmit the second PRDCH during a monitoring time window, and
the monitoring time window is (i) predefined, (ii) indicated in the first PRDCH, or (iii) based on the randomly selected resource.

18. The reader of claim 15, wherein the second PRDCH (i) corresponds to a number of receptions of the first PDRCH from respective number of devices, (ii) includes random numbers provided in the number of receptions of the first PDRCH, and (iii) provides information related to a number of receptions of the second PDRCH.

19. The reader of claim 15, wherein the information related to reception of the second PDRCH includes at least one of:
a timing indication for reception of the second PDRCH from the reception of the second PRDCH,
a frequency resource for reception of the second PDRCH,
a request for additional information related to the IoT device, and
parameters related to a transmission rate of the second PDRCH.

20. The reader of claim 15, wherein
the first PDRCH is not expected to be received earlier than T₁ after transmission of the first PRDCH,
the second PDRCH is not expected to be received earlier than T₁ after transmission of the second PRDCH,
the second PRDCH is not expected to be transmitted earlier than T₂ after reception of the first PDRCH, and
T₁ and T₂ are time durations.
